(19) United States
(12) Patent Application Publication
(10) Pub. No.: US 2021/0383299 A1
(43) Pub. Date: Dec. 9, 2021

(54) PIPELINE RENEWAL SUPPORT DEVICE AND PIPELINE RENEWAL SUPPORT METHOD

(71) Applicant: HITACHI, LTD., Tokyo (JP)

(72) Inventors: Shinsuke TAKAHASHI, Tokyo (JP); Kenji KOIZUMI, Tokyo (JP); Takaharu MASUIKE, Tokyo (JP)

(21) Appl. No.: 17/330,484

(22) Filed: May 26, 2021

(30) Foreign Application Priority Data
Jun. 5, 2020 (JP) 2020-098389

(51) Int. Cl. G06Q 10/06; G06N 5/04

(52) U.S. Cl. CPC G06Q 10/06313; G06N 5/04

(57) ABSTRACT

An object of the invention is to determine an appropriate renewal time for a pipeline while considering a predetermined renewal time and cost. A pipeline renewal support device includes a calculation device configured to execute a renewal plan calculation process of calculating a time for renewal of a pipeline with a predetermined attribute to be performed at a predetermined reference time in the future or at a time before and after the reference time under a predetermined constraint condition on a renewal cost of the pipeline.

### CROSS-REFERENCE TO RELATED APPLICATION

This application claims priority pursuant to 35 U.S.C. § 119 from Japanese Patent Application No. 2020-098389, filed on Jun. 5, 2020, the entire disclosure of which is incorporated herein by reference.

### BACKGROUND

### 1. Technical Field

The present invention relates to a pipeline renewal support device and a pipeline renewal support method.

### 2. Related Art

An operator who manages a pipeline such as a water pipe or the like periodically renews a part of the pipeline as necessary in order to maintain the safety of the pipeline or prevent the deterioration thereof.

As a technique for detecting deterioration of a pipeline, for example, WO 2013/145493 (Patent Literature 1) discloses that a water leakage sensor provided in a water distribution pipeline network detects a water leakage, and an aging characteristic graph of the pipeline is created based on past water leakage experience information; in the aging characteristic graph, the horizontal axis represents years of service of the pipeline and the vertical axis represents a sensor output change (which is also an index of the deterioration of the pipeline); and a relation therebetween is graphed so that a degree of the deterioration of the pipeline with a passage of year is grasped.

Regarding a water pipe, a renewal reference year (renewal interval) for a pipeline is usually set in advance according to an attribute of the pipeline, and an operation is being implemented according to this renewal reference year. However, in Patent Literature 1, although the degree of the deterioration of the pipeline can be estimated, a renewal time is not taken into consideration. Therefore, there is a problem that a renewal cost of the pipeline becomes higher than necessary, and the operation of an operator may not be performed efficiently.

### SUMMARY

The invention is made in view of such a situation, and an object thereof is to provide a pipeline renewal support device and a pipeline renewal support method which are capable of determining an appropriate renewal time of a pipeline while considering a predetermined renewal time and cost.

One aspect of the invention for solving the above problem is a pipeline renewal support device including a calculation device configured to execute a renewal plan calculation process of calculating a time for renewal of a pipeline with a predetermined attribute to be performed at a predetermined reference time in the future or at a time before and after the reference time under a predetermined constraint condition on a renewal cost of the pipeline.

Further, another aspect of the invention for solving the above problem is a pipeline renewal support method implemented by an information processing device to execute a renewal plan calculation process of calculating a time for renewal of a pipeline with a predetermined attribute to be performed at a predetermined reference time in the future or at a time before and after the reference time under a predetermined constraint condition on a renewal cost of the pipeline.

According to the invention, it is possible to determine an appropriate renewal time of a pipeline while considering a predetermined renewal time and cost.

Problems, configurations and effects other than those described above will be clarified by the description of the following embodiment.

### BRIEF DESCRIPTION OF THE DRAWINGS

FIG. 1 is a diagram illustrating an example of a configuration of a pipeline renewal support device according to the present embodiment.

FIG. 2 is a diagram illustrating an example of contents of pipeline length data.

FIG. 3 is a diagram illustrating an example of renewal reference year data.

FIG. 4 is a diagram illustrating an example of pipeline renewal cost data.

FIG. 5 is a diagram illustrating an outline of processes performed by the pipeline renewal support device.

FIG. 6 is a flowchart illustrating an example of a renewal plan preparation process.

FIG. 7 is a diagram illustrating an example of contents of future renewal pipeline length data.

FIG. 8 is a diagram illustrating an example of contents of future pipeline investment amount preparation data.

FIG. 9 is a flowchart illustrating an example of a renewal plan calculation process.

FIG. 10 is a diagram illustrating an example of a penalty function.

FIG. 11 is a diagram illustrating an example of the penalty function.

FIG. 12 is a diagram illustrating a decision variable in a mathematical programming method of the present embodiment.

FIG. 13 is a diagram illustrating a first constraint condition in the mathematical programming method of the present embodiment.

FIG. 14 is a diagram illustrating a second constraint condition in the mathematical programming method of the present embodiment.

FIG. 15 is a diagram illustrating an objective function in the mathematical programming method of the present embodiment.

FIG. 16 is a diagram illustrating an example of a proposal screen for pipeline investment amount.

FIG. 17 is a diagram illustrating an example of a detail screen for pipeline investment amount.

FIG. 18 is a flowchart illustrating an example of an index value calculation process.

FIG. 19 is a diagram illustrating an example of a proposal screen for pipeline renewal length.

FIG. 20 is a diagram illustrating an example of a comparison screen for cost condition.

FIG. 21 is a diagram illustrating an example of a tradeoff graph screen.

### DESCRIPTION OF EMBODIMENTS

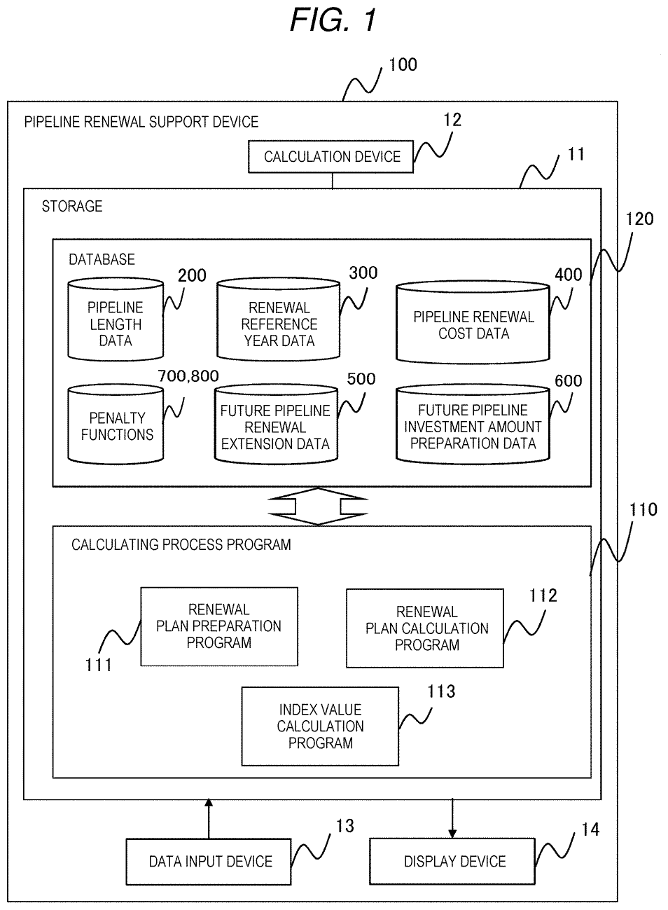

FIG. 1 is a diagram illustrating an example of a configuration of a pipeline renewal support device 100 according to the present embodiment.

The pipeline renewal support device 100 is managed by, for example, a predetermined operator or other management agent (hereinafter, referred to as the user) that manages a pipeline system including pipelines (here, water pipes) with various attributes (DIP, VP, and the like described later). In this pipeline system, it is a principle that parts of the pipelines of these attributes are periodically renewed to new pipelines at a renewal interval (renewal reference year) predetermined for each attribute of the pipelines.

Regarding the pipelines of the attributes renewed according to such a renewal reference year, the pipeline renewal support device 100 proposes an appropriate renewal time and cost investment by appropriately distributing the renewal time for those pipelines while satisfying a predetermined budgetary constraint.

As shown in FIG. 1, the pipeline renewal support device 100 includes a calculation device 12 implemented by a CPU or the like, a storage 11 implemented by a read only memory (ROM), a random access memory (RAM), a hard disk drive (HDD), a solid state disk (SSD), or the like, an input device 13 implemented by an interface such as a keyboard or a mouse, and a network interface that captures data from an external network, and a display device 14 such as a display.

Further, the pipeline renewal support device 100 stores programs of a renewal plan preparation program 111, a renewal plan calculation program 112, and an index value calculation program 113 for implementing functions.

Further, the pipeline renewal support device 100 stores various data in a database 120, which includes pipeline length data 200, renewal reference year data 300, pipeline renewal cost data 400, future pipeline renewal length data 500, future pipeline investment amount preparation data 600, and penalty functions 700, 800.

The renewal plan preparation program 111 calculates a renewal length for the pipelines of the attributes and a cost related thereto when the renewal is performed according to the renewal reference year based on a past laying length for the pipelines of the attributes and a cost related to pipeline renewal per unit length.

The renewal plan preparation program 111 stores these calculation results in the future pipeline renewal length data 500 and the future pipeline investment amount preparation data 600.

The past laying length for the pipelines of the attributes is stored in the pipeline length data 200. Further, the renewal reference year for the pipelines of the attributes is stored in the renewal reference year data 300. The cost related to length renewal per unit length of the pipelines of the attributes is stored in the pipeline renewal cost data 400.

### (Pipeline Length Data)

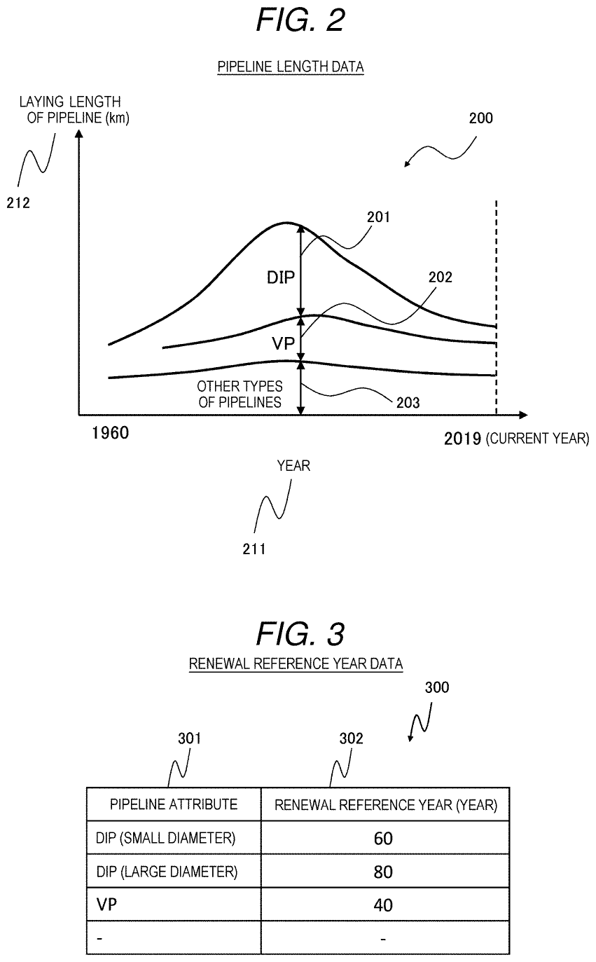

FIG. 2 is a diagram illustrating an example of contents of the pipeline length data 200. The pipeline length data 200 includes data of the laying lengths 201, 202, 203 which are the lengths of the pipelines 212 of the attributes laid in each year in the past 211 with a certain year (2019 in FIG. 2) as the current year.

In the example of FIG. 2, regarding renewal lengths implemented from 1960 or 1980 to 2019 (current year), a renewal length 201 of a ductile iron pipe (DIP) having a small diameter, a renewal length 202 of a vinyl pipe (VP), and a renewal length 203 of pipelines of other attributes (steel pipe (SP), cast iron pipe (CIP), DIP having a large diameter, and the like) are set in the pipeline length data 200.

The pipeline length data 200 is generated, for example, in a manner that the pipeline renewal support device 100 receives data input from the user.

### (Renewal Reference Year Data)

FIG. 3 is a diagram illustrating an example of the renewal reference year data 300. The renewal reference year data 300 includes one or a plurality of records each having items including a pipeline attribute 301, which is an attribute of the pipeline, and a renewal reference year 302 of the pipeline related to the pipeline attribute 301. In the example of FIG. 3, the renewal reference years for the “DIP (small diameter)” and the “VP” are 60 years and 40 years, respectively.

The renewal reference year data 300 is generated, for example, in a manner that the pipeline renewal support device 100 receives the data input from the user.

### (Pipeline Renewal Cost Data)

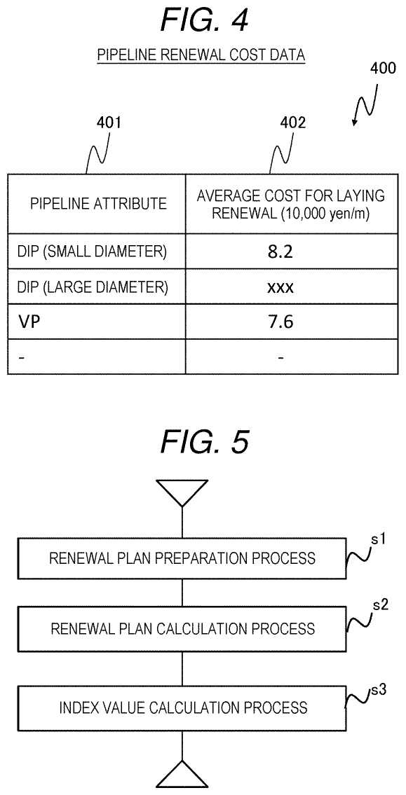

FIG. 4 is a diagram illustrating an example of the pipeline renewal cost data 400. The pipeline renewal cost data 400 includes one or a plurality of records each having items including a pipeline attribute 401, which is an attribute of the pipeline, and a unit length renewal cost 402 of the pipeline related to the pipeline attribute 401, which is an average cost for the renewal of the unit length.

The pipeline renewal cost data 400 is generated, for example, in a manner that the pipeline renewal support device 100 receives the data input from the user.

Then, as shown in FIG. 1, the renewal plan calculation program 112 executes a renewal plan calculation process of calculating the time for renewal of the pipelines of each attribute, which is performed at each renewal year on the basic of the renewal reference year (hereinafter, referred to as standard renewal time or reference time) or at a year before and after the renewal year, under a cost condition on the renewal cost of the pipelines of each attribute.

Specifically, based on an objective function having the minimum value at the renewal year on the basic of the renewal reference year and using a value of a penalty function and the pipeline renewal cost as input variables, and the above-mentioned cost condition for the objective function, the renewal plan calculation program 112 calculates a renewal time during which the value of the objective function is minimized.

In the present embodiment, the cost condition is a condition that the renewal cost of the pipeline must satisfy a predetermined condition in a predetermined period.

Specifically, it is assumed that the renewal cost for each year before a predetermined year set by the user must be a target value, and the renewal cost for each year after the predetermined year must be a predetermined upper limit or less.

In the present embodiment, two types of penalty functions (a first function and a second function) are used. That is, regarding the value for each year before and after the renewal year on the basic of the renewal reference year, there is a relation that one value (the first function) is always higher than other value (the second function).

The renewal plan calculation program 112 calculates a future renewal time of the pipeline based on the value of the first function, the objective function, and the cost condition, and also calculates the future renewal time of the pipeline based on the value of the second function, the objective function, and the cost condition.

Next, the index value calculation program 113 displays a relation between a predetermined index value representing a future risk of the pipeline and the cost condition on a screen based on the future renewal time of the pipeline calculated by the renewal plan calculation program 112.

For example, the index value calculation program 113 calculates a value representing a future water leakage risk of the pipeline as the index value based on the future renewal time of the pipeline calculated by the renewal plan calculation program 112, the years of service of the pipeline, and a water leakage loss.

Further, the index value calculation program 113 displays information indicating an index value such as the number of future water leakage accidents of the pipeline calculated by the renewal plan calculation program 112 on the screen.

The above functions of the pipeline renewal support device 100 are implemented by a special hardware or by reading and executing programs stored in the storage 11 by the calculation device 12. Further, the programs may be recorded in advance on an external storage medium, or may be introduced when necessary via a predetermined communication network.

### —Processes—

Next, the processes performed by the pipeline renewal support device 100 are described.

FIG. 5 is a diagram illustrating an outline of the processes performed by the pipeline renewal support device 100. The pipeline renewal support device 100 executes a renewal plan preparation process s1, a renewal plan calculation process s2, and an index value calculation process s3.

The details of these processes are described below.

### ——Renewal Plan Preparation Process——

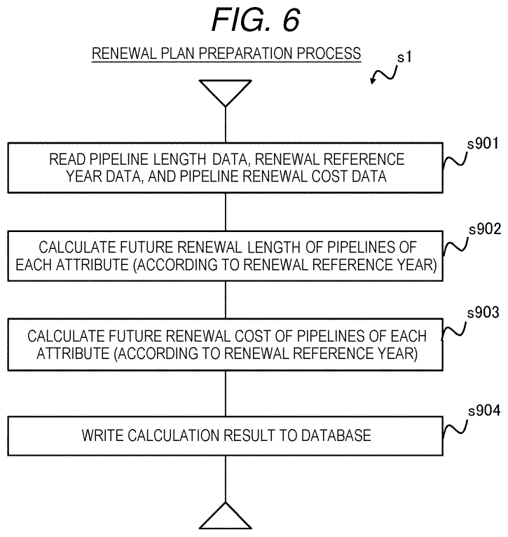

FIG. 6 is a flowchart illustrating an example of the renewal plan preparation process s1. The renewal plan preparation process s1 is executed, for example, when the pipeline renewal support device 100 receives a predetermined input from the user, or at a predetermined timing (for example, a predetermined time, a predetermined time interval).

First, the renewal plan preparation program 111 of the pipeline renewal support device 100 reads data on the past laying lengths of the pipelines of the attributes, data on the renewal reference years of the pipelines of the attributes, and data on the renewal costs of the pipelines of the attributes (s901).

Specifically, the renewal plan preparation program 111 acquires the contents of the pipeline length data 200, the renewal reference year data 300, and the pipeline renewal cost data 400, respectively.

The renewal plan preparation program 111 calculates a future renewal length of the pipelines of the attributes based on respective data read in s901 (s902). The renewal plan preparation program 111 stores the calculated future renewal length in the future pipeline renewal length data 500 in a later process (s904).

Specifically, for example, the renewal plan preparation program 111 calculates, basic on the pipeline length data 200 acquired in s901, the future renewal length of the pipelines of the attributes when it is assumed that the past laid pipeline length of the pipelines of the attributes is to be renewed afterward based on the renewal reference year. The renewal plan preparation program 111 stores the calculated future renewal length in the future pipeline renewal length data 500.

That is, the renewal plan preparation program 111 only shifts the laying lengths in past years for the pipelines of the attributes indicated by the pipeline length data 200 to the future by the renewal reference year of the pipelines of the attributes indicated by the renewal reference year data 300.

Here, a specific example of the future pipeline renewal length data 500 is described.

### (Future Pipeline Renewal Length Data)

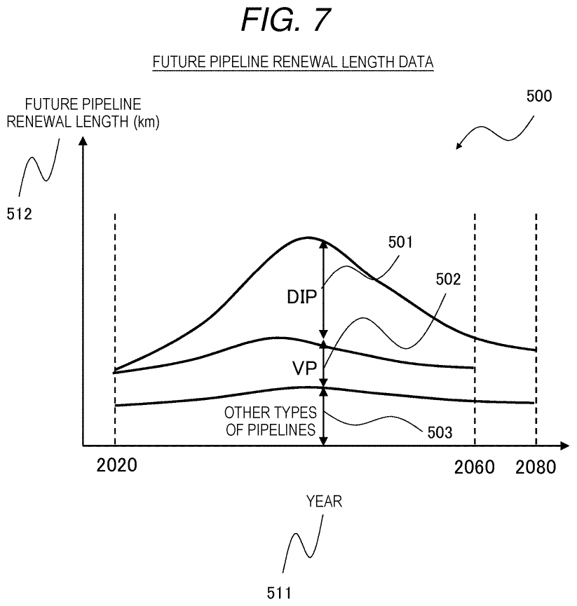

FIG. 7 is a diagram illustrating an example of the contents of the future pipeline renewal length data 500. The future pipeline renewal length data 500 includes data of renewal lengths 501, 502, and 503 which are values of a pipeline renewal length 512 of the pipelines of the attribute for each year in the future 511 when it is assumed that the pipelines of the attributes are renewed based on the renewal reference year.

In the example of FIG. 7, the renewal length of DIP (small diameter) 501, the renewal length of VP 502, and the renewal lengths of other pipelines (SP, CIP, and the like) 503 from 2020, which is the year following the current year, to the standard renewal time (which is different depending on the attributes of the pipeline. For example, 2060 and 2080) thereafter are set in the future pipeline renewal length data 500, respectively.

Next, as shown in s903 of FIG. 6, the renewal plan preparation program 111 calculates the future renewal cost of the pipelines of the attributes. The renewal plan preparation program 111 stores the calculated cost in the future pipeline investment amount preparation data 600 in the later process (s904).

Specifically, for example, the renewal plan preparation program 111 multiplies the renewal lengths of the pipelines of the attributes in each year in the future pipeline renewal length data 500 which are calculated in s902, by renewal costs 402 of records related to the pipelines of the attributes in the pipeline renewal cost data 400 which are acquired in s901, so as to calculate the future renewal cost, and stores the cost in the future pipeline investment amount preparation data 600. Thereby, the renewal plan preparation process s1 is completed.

Here, a specific example of the future pipeline investment amount preparation data 600 is described.

### (Future Pipeline Investment Amount Preparation Data)

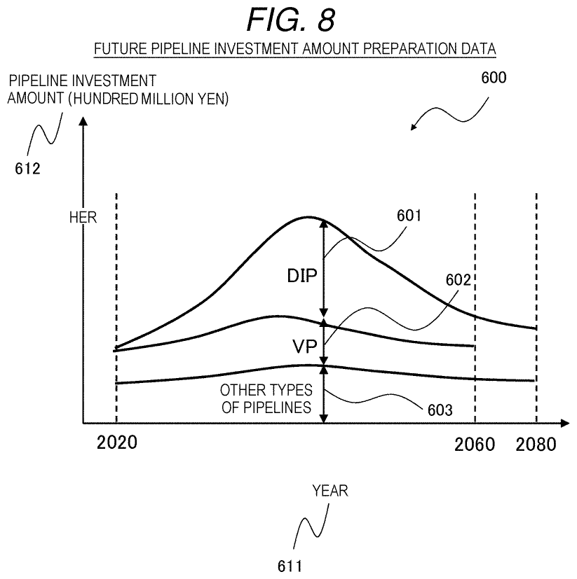

FIG. 8 is a diagram illustrating an example of the contents of the future pipeline investment amount preparation data 600. The future pipeline investment amount preparation data 600 includes data of future costs 601, 602, and 603, which are costs for the pipelines of the attribute that are renewed and laid in each year 611.

In the example of FIG. 8, the future renewal cost of DIP (small diameter) 601, the future renewal cost of VP 602, and the future renewal cost of other pipelines (SP, CIP, and the like) 603 from 2020, which is the year following the current year, to the standard renewal time (which is different depending on the pipelines, for example, 2060 or 2080) thereafter are set in the future pipeline investment amount preparation data 600, respectively.

### ——Renewal Plan Calculation Process——

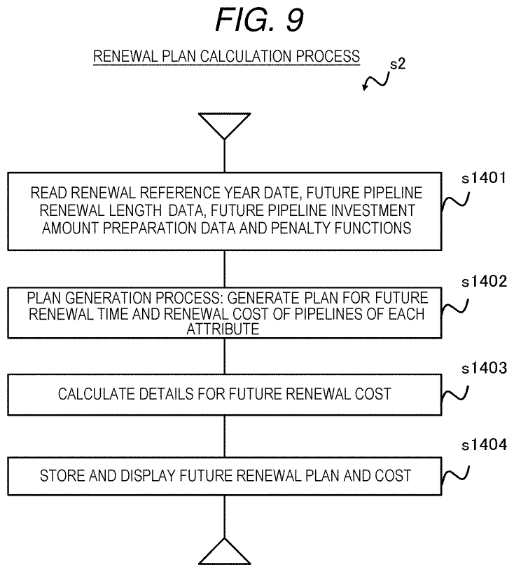

Next, FIG. 9 is a flowchart illustrating an example of the renewal plan calculation process s2. After the renewal plan preparation process s1 is completed, the renewal plan calculation process s2 is executed, for example, when the pipeline renewal support device 100 receives the predetermined input from the user, or at a predetermined timing (for example, a predetermined time, a predetermined time interval).

First, the renewal plan calculation program 112 of the pipeline renewal support device 100 reads the data calculated in the renewal plan preparation process s1 and other necessary information (s1401). Specifically, for example, the renewal plan calculation program 112 reads the renewal reference year date 300, the future pipeline renewal length data 500, the future pipeline investment amount preparation data 600 and the penalty functions 700 and 800.

Here, the penalty functions 700 and 800 are described.

### (Penalty Function)

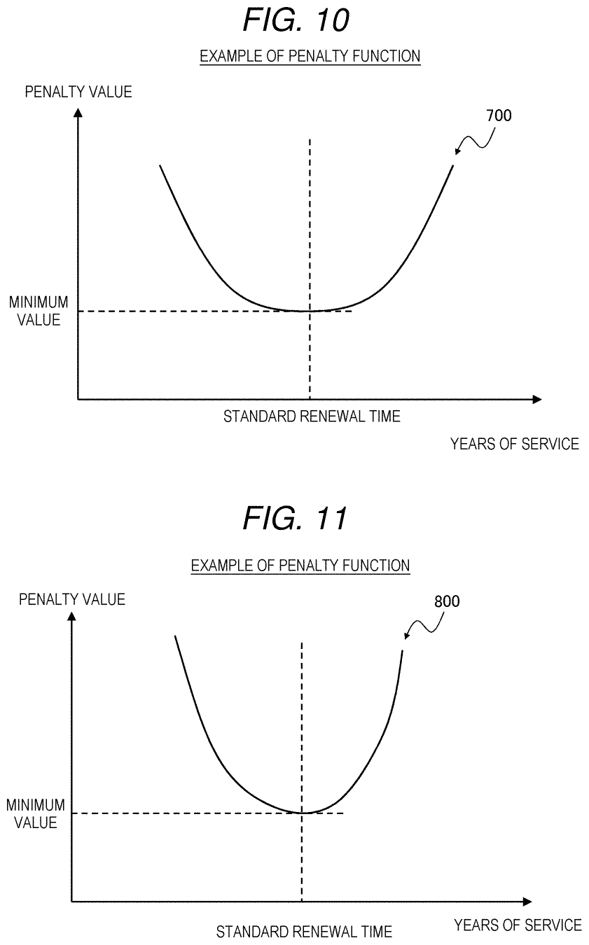

FIGS. 10 and 11 are diagrams illustrating examples of the penalty functions 700 and 800. The penalty functions 700 and 800 are set, for example, in a manner that the pipeline renewal support device 100 receives the input of a function expression from the user in advance.

For example, as shown in FIG. 10, regarding the first penalty function 700, a penalty value at the standard renewal time (renewal reference year) is the smallest, and the differences from the penalty values at adjacent times before and after this standard renewal time are small (bathtub curve). The first penalty function 700 is adopted, for example, when it is allowed to some extent to move the investment in the pipelines to the times before and after this standard renewal time.

As shown in FIG. 11, regarding the second penalty function 800, the penalty value at the standard renewal time (renewal reference year) is the smallest, and the penalty values at the times before and after this standard renewal time are always larger than the penalty values at the corresponding times of the first penalty function 700. The second penalty function 800 is adopted when the distribution of investment time with respect to the pipelines is stricter than that of the first penalty function 700 (when it is desired to further reduce the distribution).

Thus, the penalty functions 700 and 800 have the shape of a downwardly convex curve with reference to the standard renewal time (renewal reference year). Further, the penalty functions 700 and 800 are set for each attribute of the pipelines in the present embodiment.

Next, as shown in s1402 of FIG. 9, the renewal plan calculation program 112 receives the input of information on the cost condition related to the pipeline renewal from the user.

Specifically, for example, the renewal plan calculation program 112 receives the inputs of a target value (corresponding to the budget, hereinafter, referred to as the target value) of the renewal cost for all pipelines in each year in the future and an upper limit value thereof from the user.

The renewal plan calculation program 112 executes a plan generation process, which is a process of calculating the renewal time and the renewal cost of the pipelines of the attributes, based on the information acquired in s1401 (s1402).

Specifically, the renewal plan calculation program 112 calculates the future renewal times of the pipelines of the attributes by using a mathematical programming method or the like so that the value of the predetermined objective function is minimized while the cost condition is satisfied.

Hereinafter, a specific example of the plan generation process using the mathematical programming method is described.

### <Plan Generation Process>

The mathematical programming method in the plan generation process determines the value of each decision variable when the value of the objective function is minimized under the cost condition, the objective function using the values of multiple decision variables (the renewal cost for the length of the pipelines of the attributes) and the values of the penalty functions 700 and 800 as the input variables.

Furthermore, each of the decision variables, the constraint conditions, and the objective functions (the details are described below) is set, for example, in a manner that the pipeline renewal support device 100 receives the data input from the user in advance.

### (Decision Variables)

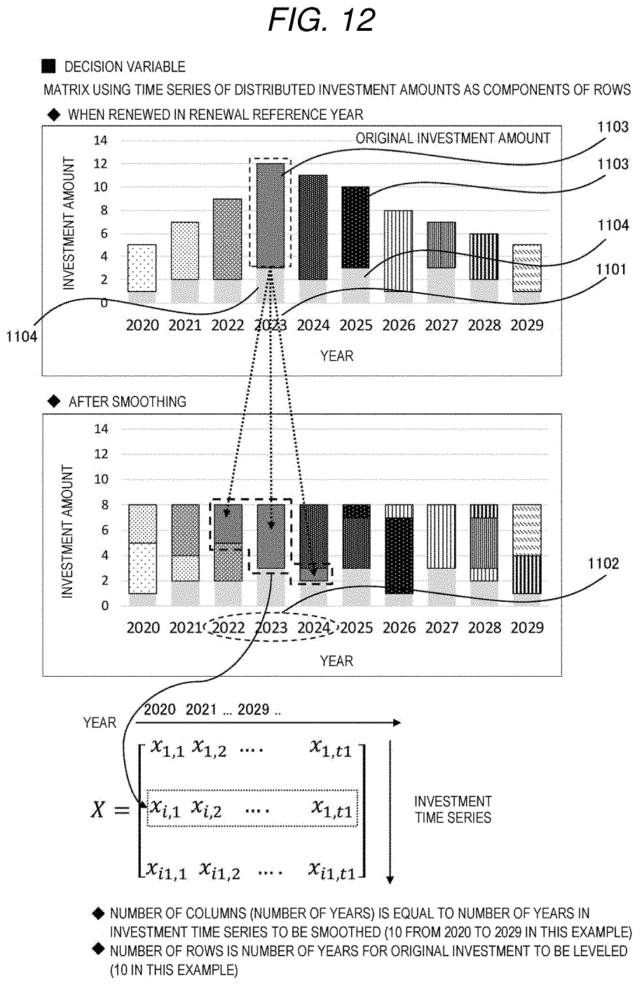

FIG. 12 is a diagram illustrating the decision variable in the mathematical programming method of the present embodiment. This decision variable is a variable that represents the renewal costs for the pipelines of the attributes when the pipeline renewal (investment) at a standard renewal time 1101 is distributed to the standard renewal time 1101 and times 1102 (year) before and after the standard renewal time.

In addition, the renewal cost of each year when the pipelines are renewed at the standard renewal time 1101 is hereinafter referred to as an original investment amount. This original investment amount is equal to the investment amount shown in the future pipeline investment amount preparation data 600. In the example of FIG. 12, a sum of investment amounts 1103 before the distribution which are to be distributed and fixed investment amounts 1104 corresponds to the original investment amount. Since the original investment amount generally has an arched change, it is necessary to smooth the original investment amount due to future budget constraints. In FIG. 12, the original investment amount in 2023 is distributed over three years from 2022 to 2024, and the original investment amount may be distributed over more years.

The decision variables of the present embodiment are set only for the pipelines of some attributes among the pipelines of the attributes (Hereinafter, referred to as pipelines to be distributed. In FIG. 12, pipelines including DIP, and VP having a small diameter.), and is not set for the pipelines of other attributes (hereinafter referred to as pipelines other than those to be distributed). For example, the investment amount 1104 belonging to a part whose investment amount is not distributed, which is shown in FIG. 12, is the investment amount (renewal cost) of the pipelines other than those to be distributed, and is a fixed investment amount in each year.

Specifically, the decision variable of the present embodiment is represented by a matrix X which has a component x_{i,t} (1≤i≤i₁, 1≤t≤t₁) representing the renewal cost (investment amount). The i in each row indicates the investment in the i-th year covered by the original investment (the sum of the investment amount 1103 to be distributed and the fixed investment amount 1104 that is not distributed), which is the distribution source of the renewal time (cost). In addition, the t in each column represents the renewal year after the distribution.

That is, as shown by a curved arrow extending from the bar graph (graph of the investment amount after the distribution) at the bottom of FIG. 12 to the matrix X, the matrix X uses a series of investment amounts in which the i-th (4th in FIG. 12, 2023) original investment amount is distributed in the years (2020 to 2029 in FIG. 12) before and after the renewal reference year as the component (x_{i,t} (1≤t≤t1)) of the i-th row (4th in FIG. 12).

### (Constraint Conditions)

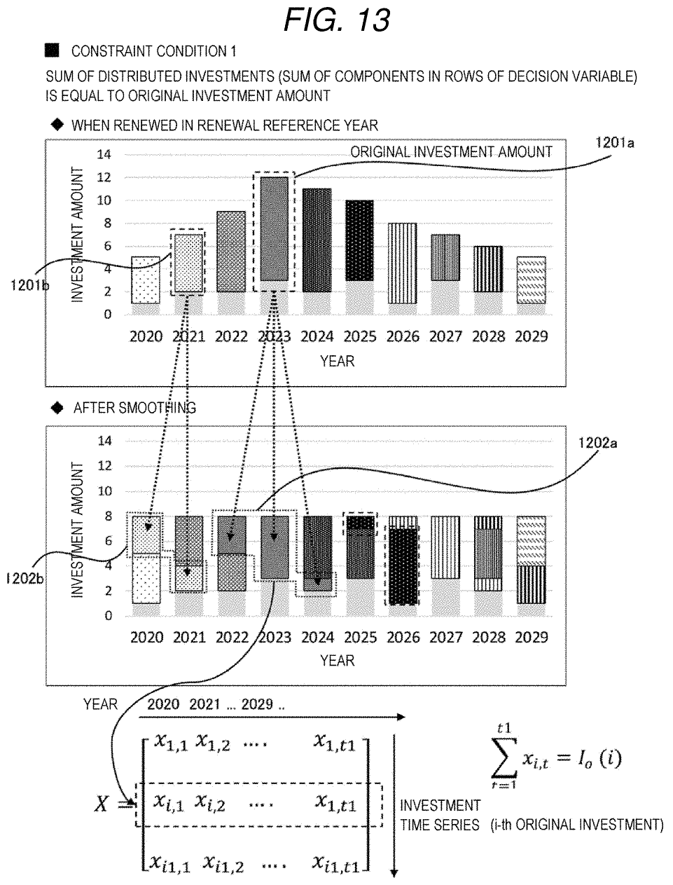

FIG. 13 is a diagram illustrating a first constraint condition (cost condition) in the mathematical programming method of the present embodiment.

The first constraint condition is a condition that original investment amounts 1201 (1201a, 1201b) which are future investments when the pipelines of the attributes are renewed at the standard renewal time are equal to a sum of investment amounts 1202 (1202a, 1202b) (renewal costs) after the renewal costs of the original investment amounts 1201 are distributed (that is, a total cost does not change before and after the distribution of cost (time)).

Specifically,

$${\sum }_{t = 1}^{t 1} {x}_{i , t} = {I}_{0} ( i )$$

Here, I₀(i) is the original investment amount in a time i.

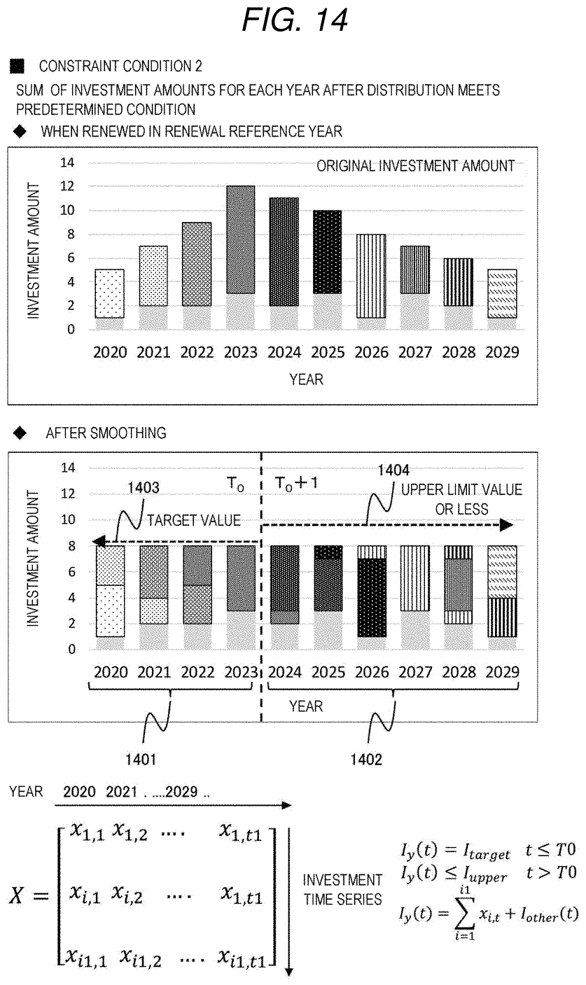

Next, FIG. 14 is a diagram illustrating a second constraint condition (cost condition) in the mathematical programming method of the present embodiment.

The second constraint condition is a cost condition that the renewal cost of all pipelines in each time after the renewal time is distributed satisfies a predetermined condition.

For example, it is a condition that the renewal cost of all pipelines (the pipelines to be distributed and the pipelines other than those to be distributed) in each year 1401 from the current year to a future predetermined year T₀ is a predetermined target value 1403, and the renewal cost of all pipelines (the pipelines to be distributed and the pipelines other than those to be distributed) in each year 1402 since a predetermined year (T₀+1) is equal to or less than a predetermined upper limit value 1404.

Specifically,

$${I}_{y} ( t ) = {I}_{target} ( t \leq {T}_{0} )$$

$${I}_{y} ( t ) \leq {I}_{upper} ( t > {T}_{0} )$$

$${I}_{y} ( t ) = {\sum }_{i = 1}^{i 1} {x}_{i , t} + {I}_{other} ( t )$$

Here, I_{target} is the target value, Iᵤₚₚₑᵣ is the upper limit value, and Iₒₜₕₑᵣ(t) is a total renewal cost of the pipelines other than those to be distributed.

Further, the second constraint condition may be a condition that the renewal cost of all pipelines (pipelines to be distributed and pipelines other than those to be distributed) in each year since the current year is always a predetermined target value.

In addition, the second constraint condition may be a condition that the renewal cost of all pipelines (pipelines to be distributed and pipelines other than those to be distributed) in each year since the current year shows a predetermined time change (for example, increase or decrease at a certain rate). That is, the target value is not a fixed value and may be variable.

The second constraint condition may be a combination of these multiple patterns, or may be added with other conditions. The determination of the second constraint condition is based on, for example, the projection of future cost or budget uncertainties, and constraints in numerical calculations (for example, the value does not converge to the predetermined value, or the like).

### (Objective Function)

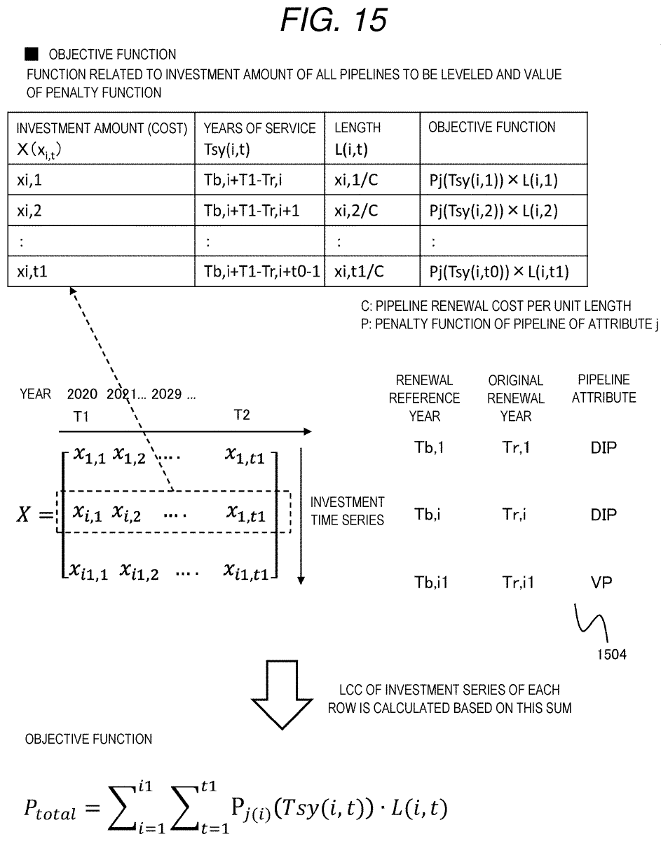

FIG. 15 is a diagram illustrating the objective function of the present embodiment.

The objective function is a function for calculating a sum of the penalty values of all pipelines for investment (renewal) in a predetermined time in the future (for example, a life cycle cost of the pipelines may be used in addition to the penalty value).

That is, when the future renewal times of the pipeline of the attributes are distributed to the times before and after the standard renewal time, the values of the penalty functions 700 and 800 calculated based on the years of service of the pipelines of the attributes are respectively multiplied by the renewal length obtained by dividing the renewal cost of the pipelines of the attributes by the cost per unit length, and the objective function is a value that is a sum of the multiplied values for all times and the pipelines of all attributes.

Specifically, for example,

Pₜₒₜₐₗ=Σᵢ₌₁ⁱ¹Σₜ₌₁^{t1}Pⱼ₍ᵢ₎(T_{sy}(i,t))·L(i,t)

Here, Pₜₒₜₐₗ is the value of the objective function, P (i) means the values of the penalty functions 700, 800 for the pipeline of the pipeline attribute j with respect to the i-th original investment, T_{sy}(i,t) means the years of service of the pipelines corresponding to the distributed investment amount x_{i,t}, and L(i,t) means the pipeline length corresponding to the distributed investment amount x_{i,t}.

Next, as shown in s1403 of FIG. 9, the renewal plan calculation program 112 generates detailed information on the future renewal cost of the pipelines based on the renewal time of the pipelines of the attributes calculated in s1402.

The renewal plan calculation program 112 displays the renewal time of the pipelines calculated in s1402 on a proposal screen for pipeline investment amount 1500. Further, the renewal plan calculation program 112 displays the detailed information generated in s1403 on a detail screen for pipeline investment amount 1600 (s1404). The renewal plan calculation program 112 stores these displayed contents in a database 120.

Here, specific examples of the pipeline investment amount proposal screen 1500 and the pipeline investment amount detail screen 1600 are described.

### (Proposal Screen for Pipeline Investment Amount)

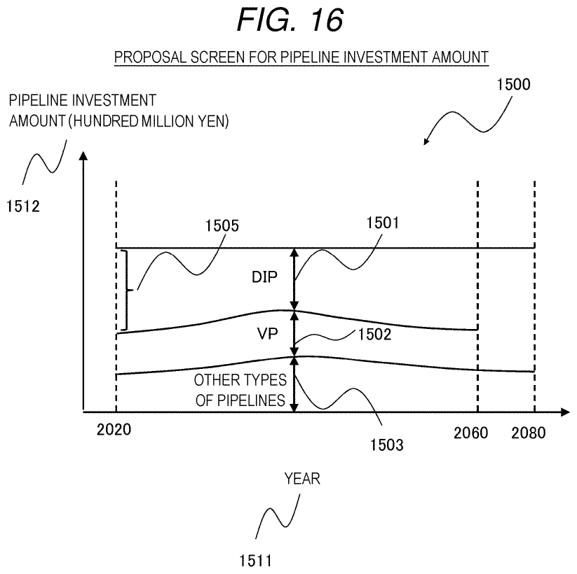

FIG. 16 is a diagram illustrating an example of the proposal screen for pipeline investment amount 1500.

The proposal screen for pipeline investment amount 1500 is a screen showing the time change of the cost (investment amount) on the renewal length of the pipelines of the attributes in which the renewal time (cost) is distributed.

That is, the proposal screen for pipeline investment amount 1500 displays the time changes of optimized investment amounts 1501, 1502, and 1503, which are the investment amounts 1512 for the pipelines of the attributes laid in each year 1511. The optimized investment amount is obtained by solving a mathematical programming problem consisting of the above-mentioned decision variables, constraint conditions, and objective functions, and for example, the investment amounts for DIP and VP for each future year can be calculated by summing the components of columns in the matrix X obtained by solving the mathematical programming problem. A correspondence between a component in a column and a pipeline attribute can be grasped by referring to, for example, pipeline attribute information 1504 shown on the right side of the matrix X in FIG. 15.

### (Detail Screen for Pipeline Investment Amount)

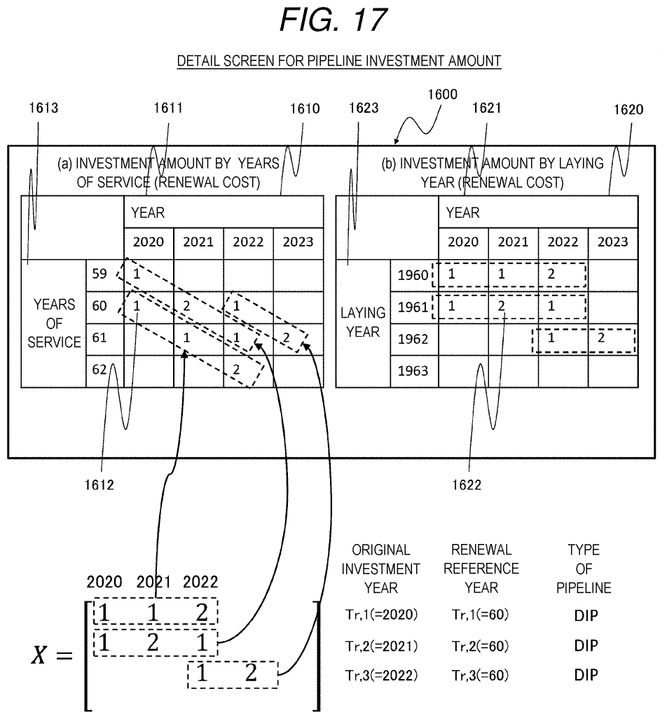

FIG. 17 is a diagram illustrating an example of the detail scree for pipeline investment amount 1600. The detail scree for pipeline investment amount 1600 includes a screen for investment amount by years of service 1610 which is a screen showing a pipeline renewal cost 1612 (investment amount) in each future renewal year 1611 by years of service 1613 of the pipelines, and a screen for investment amount by laying year 1620 which is a screen showing a pipeline renewal cost 1622 (investment amount) in each future renewal year 1621 by laying year 1623 of the pipelines.

Here, a specific example of a generation method from the matrix X to the screen for investment amount by years of service 1610 is described.

First, the rows of the matrix X are years (2020, 2021, 2022) of the original investment, the columns (2020, 2021, 2022) of the matrix X show the renewal time of the pipeline during which the renewal time is distributed, the attributes of the pipeline are all DIP (small diameter), and the renewal reference year thereof is 60 years.

In this case, the value (cost or investment amount) of the first row and first column in the matrix X is “1”. The pipeline to be renewed for this investment amount is a pipeline laid in 2020−60=1960 since the year of original investment is 2020 and the renewal reference year is 60 years. In addition, since this investment is invested in 2020, the years of service in that year is 2020−1960=60 years. Therefore, on the screen for investment amount by years of service 1610, the renewal cost of the pipeline for which the years of service 1613 is 60 years and the renewal year 1611 (investment year) is 2020 is “1”. Regarding other factors, the cost is calculated in the same manner. For example, on the screen for investment amount by years of service 1610, the renewal cost of the pipeline for which the years of service 1613 is 59 years and the renewal year 1611 is 2000 is “1”.

Next, a specific example of a generation method from the matrix X to the screen for investment amount by laying year 1620 is described.

The value (cost or investment amount) of the first row and first column in the matrix X is “1”. The pipeline relating to this investment amount is a pipeline laid in 2020−60=1960 since the year of original investment is 2020 and the renewal reference year is 60 years. Further, since this investment is invested in 2020, as a result, on the screen for investment amount by laying year 1620, the investment amount “1” is set for the item for which the laying year 1623 is 1960 and the renewal year 1621 is 2020. Regarding other factors, the cost is calculated in the same manner. That is, data corresponding to the rows and columns of the matrix X is respectively set in the rows and columns of the screen for investment amount by laying year 1620.

### ——Index Value Calculation Process——

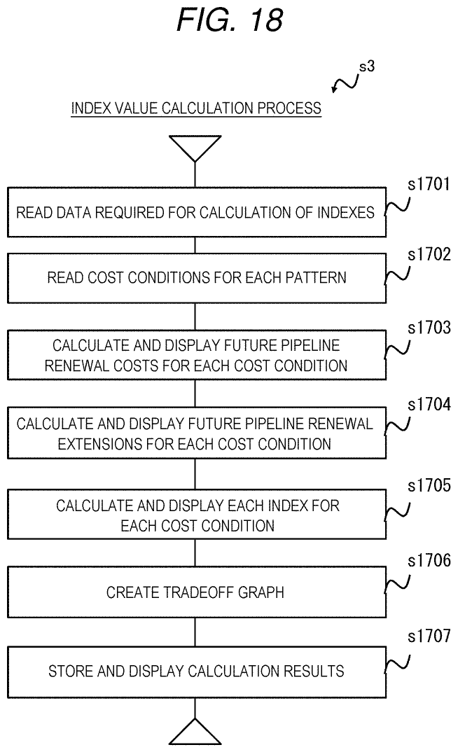

Next, FIG. 18 is a flowchart illustrating an example of the index value calculation process s3. The index value calculation process s3 calculates index values indicating the number of future accidents and risks such as future loss due to water leakage. After the renewal plan calculation process s2 is completed, the index value calculation process s3 is executed, for example, when the pipeline renewal support device 100 receives the predetermined input from the user, or at a predetermined timing (for example, a predetermined time, a predetermined time interval).

First, the index value calculation program 113 of the pipeline renewal support device 100 reads data necessary for calculating each index (s1701).

Specifically, for example, the index value calculation program 113 acquires the pipeline length data 200, the renewal reference year data 300, the pipeline renewal cost data 400, the penalty functions 700 and 800, and the future pipeline investment amount preparation data 600.

Further, the index value calculation program 113 receives the input of cost conditions (for example, target values (budget) for each year and upper limit values for each year) of one or more patterns from the user (s1702).

The index value calculation program 113 calls and executes the plan generation process s1402 of the renewal plan calculation process s2 based on the data read in s1701 and the cost conditions of each pattern input in s1702 (s1703).

Thus, the index value calculation program 113 calculates the renewal costs of the pipelines of the attributes at each time corresponding to the cost conditions of each pattern, and displays the calculated contents on the proposal screen for pipeline investment amount 1500.

Then, the index value calculation program 113 calculates the renewal length of the pipelines of the attributes at each time regarding each pattern of the cost conditions calculated in s1703 (s1704).

Specifically, for example, the index value calculation program 113 calculates the renewal length by dividing the investment amount of the pipelines of the attributes calculated in s1703 by the renewal costs 402 of records related to the pipelines of the attributes in the pipeline renewal cost data 400.

The index value calculation program 113 displays the calculated renewal length on the proposal screen for pipeline renewal length 1800.

### (Proposal Screen for Pipeline Renewal Length 1800)

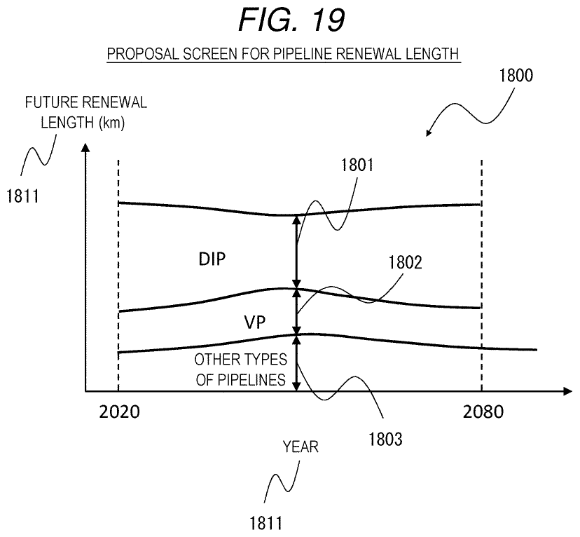

FIG. 19 is a diagram illustrating an example of the proposal screen for pipeline renewal length 1800. The time changes of the renewal lengths 1801, 1802, 1803 of the pipelines of the attributes 1812 in each year 1811 are displayed on the pipeline renewal length proposal screen 1800.

Next, as shown in s1705 of FIG. 18, the index value calculation program 113 calculates the index values of evaluation indexes based on the renewal length of the pipelines of the attributes calculated in s1704.

In the present embodiment, the index value calculation program 113 calculates a value of an index related to the total number of future accidents of the pipelines (index for the number of accidents) and a value of an index related to future water leakage amount of the pipelines (index for the loss due to water leakage) as the evaluation indexes.

First, in the calculation of the index for the number of accidents, the laying length of the pipelines of the attributes increases by the renewal length calculated in s1704 in each year in the future, while the increase amount shall be removed in order from the oldest year from the other lengths of the pipelines of the attributes.

For example, it is considered that the current year is assumed to be 2019, in 2020, the pipeline of a certain attribute is newly laid by the lengths of renewal lengths 1801, 1802, 1803 shown on the proposal screen for pipeline renewal length 1800, and the oldest pipeline of the same attribute (at least before 2018) is removed by a renewal length 1505 laid in 2020.

Based on the above, the index value calculation program 113 calculates the total number of accidents Nᵢ(T) of the pipeline of the attribute i in the future year T by, for example, the following equation.

Nᵢ(T)=Σₜ₌₀⁸⁰Lᵢ(T−t)·yᵢ(t)

Here, the above equation assumes that the years of service of the pipeline of the attribute i is 80 years at the maximum. In addition, t is the years of service of the pipeline of the attribute i, Lᵢ(T) is a length of the pipeline laid in year T for the pipeline of the attribute i, and yᵢ(t) is an accident rate of the pipeline of the attribute i for which the years of service is t. The index value calculation program 113 calculates the total number of accidents N_total (T) for all the pipelines, that is, the value of the index for the number of accidents by calculating Nᵢ(T) for all the pipelines of the attribute i and summing them up.

Furthermore, the accident rate yᵢ(t) is represented by a function, and is based on, for example, a report of “Japan Water Research Center, ‘Research on Pipeline Technology for Maintainable Water Services’ (e-Pipe Project) (March 2011)”.

Next, the index value calculation program 113 calculates a total loss due to water leakage L_total(T), that is, the value of the index for the loss due to water leakage by multiplying the value of the index for the number of accidents by the loss due to water leakage Closs per pipeline accident.

The loss due to water leakage per accident can be obtained, for example, by dividing an annual water leakage loss experience (annual water leakage amount×water supply cost) by the total number of annual accidents (excluding water pipe accidents).

The index value calculation program 113 displays these calculation results on a comparison screen for cost condition 1700 described below.

### (Comparison Screen for Cost Condition)

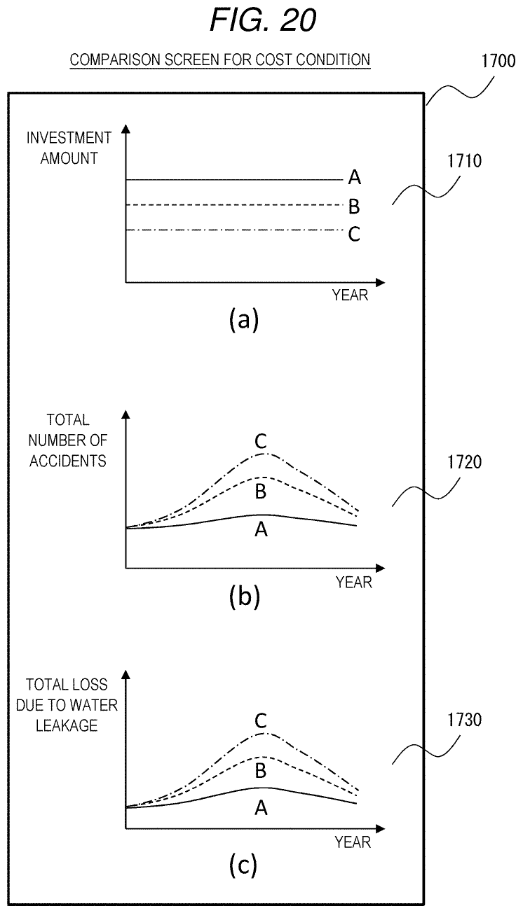

FIG. 20 is a diagram illustrating an example of the comparison screen for cost condition 1700. The comparison screen for cost condition 1700 includes a display column for comparison in investment amount 1710, a display column for comparison in index for the number of accidents 1720, and a display column for comparison in the index for loss due to water leakage 1730.

In the display column for comparison in investment amount 1710, a change in the investment amount for all pipelines in each year under the cost conditions of the patterns input in s1702 is displayed.

In the display column for comparison in the index for number of accidents 1720, a change in the value of the index for the number of accidents in each year under the cost conditions of the patterns input in s1702 is displayed.

In the display column for comparison in the index for loss due to water leakage 1730, a change in the value of the index for the loss due to water leakage in each year under the cost conditions of the patterns input in s1702 is displayed.

According to the comparison screen for cost condition 1700, it can be seen that the larger the investment amount, the more the pipeline renewal is promoted, so that the number of pipeline accidents and the risk of loss due to water leakage decrease.

Further, as shown in s1706 of FIG. 18, the index value calculation program 113 displays a tradeoff graph screen showing the relation between the investment amount and the evaluation indexes.

The index value calculation program 113 stores the results of the above processes s1703 to s1706 in the database 120. Thereby, the index value calculation process s3 is completed.

### (Tradeoff Graph Screen)

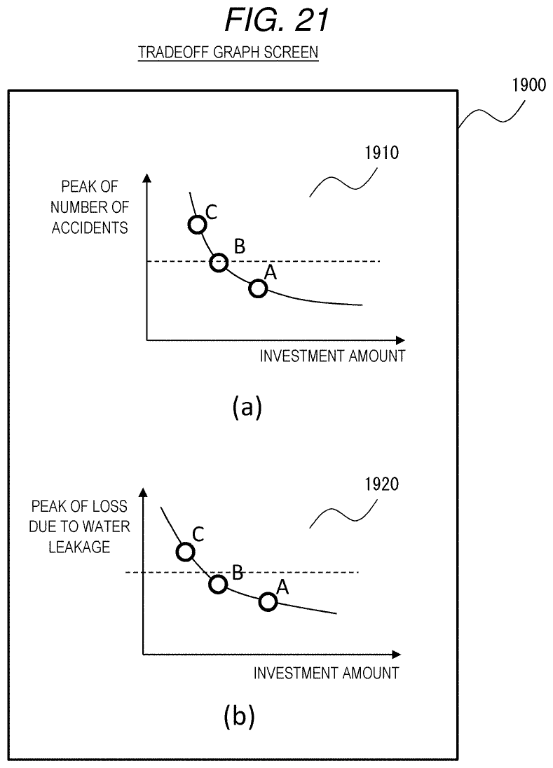

FIG. 21 is a diagram illustrating an example of the tradeoff graph screen 1900. The tradeoff graph screen 1900 includes a column displaying graph for number of accidents 1910 which shows a relation between the total value of investment amount for all the pipelines and the value of the index for the number of accidents (peak of the number of accidents), and a column displaying graph for loss due to water leakage 1920 which shows a relation between the total value of investment amount for all the pipelines and the index for the loss due to water leakage (peak of loss amount due to water leakage).

By referring to the tradeoff graph screen 1900, the user can find out, for example, an annual investment amount in which the peak of the number of accidents and the peak of the loss due to water leakage are equal to or less than predetermined upper limits. Therefore, it is possible to support decision-making regarding the investment amount for all pipelines.

As described above, information such as the future renewal plans for the pipelines, the future investment amounts calculated accordingly, the risk of future accidents, the risk of future loss due to water leakage is presented to the user with the screens displayed by the pipeline renewal support device 100 according to the present embodiment, that is, the proposal screen for pipeline investment amount 1500, the detail screen for pipeline investment amount 1600, the proposal screen for pipeline renewal length 1800, the comparison screen for cost condition 1700, and the tradeoff graph screen 1900. In addition, the relation between the evaluation indexes having a tradeoff relation and the investment amount can be calculated and visualized under various cost conditions. Therefore, it is possible to assist the user in a pipeline renewal plan-creating and a decision-making regarding the pipeline renewal plan-creating.

As described above, the pipeline renewal support device 100 according to the present embodiment calculates the renewal times of the pipelines of the attributes, which are the times according to the renewal reference year (the standard renewal time) or the times before and after these times, under the predetermined cost conditions with respect to the renewal costs of the pipelines, and thus it is possible to determine the appropriate renewal times for the pipelines of the attributes while considering the renewal reference year and cost.

For example, it is possible to create a plan such that the pipeline renewal can be performed at the time according to the renewal reference year as much as possible while satisfying the cost constraint. That is, it is possible to create the pipeline renewal plan following the intent of the user.

The invention is not limited to the embodiments described above and includes various modifications. The embodiments described above have been described in detail for better understanding of the invention, and the invention is not necessarily limited to those including all configurations described above.

For example, a part of the configuration of the pipeline renewal support device may be provided in other information processing devices. For example, a user terminal for inputting or displaying data may be provided.

Further, the future renewal length and the calculation of the renewal cost in the renewal plan preparation process are not limited to the contents shown in the renewal plan preparation process s1 of the present embodiment, and other methods also may be used. For example, the calculation based on a new renewal reference year in the future may be performed.

In addition, in the present embodiment, although the renewal reference year for the pipelines of the attributes is set to a fixed time, the renewal reference year may be other predetermined time intervals and timings.

In the present embodiment, although the renewal time of the pipelines is set on an annual basis, but the renewal time may be based on other times. For example, the renewal time may be a month or other time units.

Further, in the present embodiment, although only the pipeline renewal is considered as the cost condition, other costs may be considered. In addition, the predetermined pipeline renewal cost may be excluded.

Further, in the present embodiment, although the indexes on the number of accidents and the risk of water leakage are described as the index values, other types of indexes may be used. For example, the index may be an index of supply with respect to water demand.

Further, in a pipeline renewal plan process, the renewal time of the pipeline may be calculated for each of the penalty functions 700 and 800, and the renewal times of the pipeline may be compared.

Further, in the present embodiment, although the water pipe is listed as the pipeline, the invention can also be applied to other types of pipelines, such as pipelines that transport liquids other than water, gas pipes, or the like.

The above contents of the present description clarify at least the following. That is, in the pipeline renewal support device 100 according to the present embodiment, the calculation device may calculate, in the renewal plan calculation process, based on a predetermined objective function having the minimum value at the reference time and using a value of a predetermined function with respect to time and the renewal cost of the pipeline as input variables, and the constraint condition on the objective function, a time for renewal of the pipeline at which a value of the objective function is minimized.

Therefore, by calculating the future renewal time of the pipeline based on the objective function having the minimum value at the renewal year (standard renewal time) according to the renewal reference year and using the penalty functions 700 and 800 and pipeline renewal costs (X, T_{sy}(i, t), L(i, ti)) as the input variables, so that the value of the objective function is minimized at the future renewal time, it is possible to create a pipeline renewal plan following an operational intent of the user in which the renewal time of the pipeline is matched to the renewal reference year as much as possible.

Further, in the pipeline renewal support device 100 according to the present embodiment, the constraint condition may include a cost condition that the renewal cost of the pipeline is required to satisfy a predetermined condition in a predetermined period, and the calculation device may calculate a time for renewal of the pipeline under a constraint condition including the cost condition in the renewal plan calculation process.

Therefore, it is possible to create a pipeline renewal plan under the cost constraint assumed by the user by calculating the renewal time of the pipeline under the cost condition that changes in accordance with time.

In addition, in the pipeline renewal support device 100 according to the present embodiment, the cost condition may include a condition that a total renewal cost of the pipeline is required to be a certain value or a predetermined value or less during the time for renewal of the pipeline, and the calculation device may calculate a time for renewal of the pipeline under a constraint condition including the cost condition in the renewal plan calculation process.

Therefore, it is possible to create a pipeline renewal plan that satisfies the budget constraint assumed by the user by calculating the renewal time of the pipeline under the cost condition that the total renewal cost of the pipeline is the target value or the upper limit value or less at the renewal time of a calculation target.

Further, in the pipeline renewal support device 100 according to the present embodiment, in the renewal plan calculation process, the calculation device may acquire a first function and a second function as predetermined functions with respect to time, values of one function at each time before and after the reference time being higher than values of another function constantly, and calculate a future renewal time of the pipeline based on a value of the first function, the objective function, and the constraint condition, and calculate a future renewal time of the pipeline based on a value of the second function, the objective function, and the constraint condition.

Therefore, when the penalty functions 700 and 800 with different values (for example, different slopes) before and after the standard renewal time are used, the user can determine how much the pipeline renewal and the investment amount can be changed before and after the standard renewal time by creating the pipeline renewal plan.

Further, in the pipeline renewal support device 100 according to the present embodiment, the calculation device may execute an index value calculation process of calculating a predetermined index value indicating a future risk of the pipeline based on the calculated time for renewal of the pipeline, and display a relation between the calculated index value and a cost constraint condition of the pipeline.

Therefore, the user can evaluate a cost-effectiveness balance on the pipeline renewal by displaying the relation between an index value indicating the future risk of the pipeline and the cost constraint condition of the pipeline.

In addition, in the pipeline renewal support device 100 according to the present embodiment, the calculation device may calculate an index value indicating a future water leakage risk of the pipeline based on the calculated time for renewal of the pipeline, years of service of the pipeline, and a water leakage loss of the pipeline, and display a relation between the calculated index value and the cost constraint condition of the pipeline in the index value calculation process.

Therefore, the user can evaluate the balance between the cost on the pipeline renewal and the future water leakage risk by calculating the index value indicating the future water leakage risk of the pipeline based on the future renewal time of the pipeline, the years of service and the water leakage loss of the pipeline.

Further, in the pipeline renewal support device 100 according to the present embodiment, the calculation device may display information indicating the calculated time for renewal of the pipeline in the renewal plan calculation process.

Therefore, the user can clearly know essential points of the pipeline renewal plan by displaying the information indicating the future renewal time of the pipeline.

What is claimed is:

1. A pipeline renewal support device comprising:
a calculation device configured to execute a renewal plan calculation process of calculating a time for renewal of a pipeline with a predetermined attribute to be performed at a predetermined reference time in the future or at a time before and after the reference time under a predetermined constraint condition on a renewal cost of the pipeline.

2. The pipeline renewal support device according to claim 1, wherein
the calculation device is configured to,
in the renewal plan calculation process,
calculate, based on a predetermined objective function having the minimum value at the reference time and using a value of a predetermined function with respect to time and the renewal cost of the pipeline as input variables, and the constraint condition on the objective function, a time for renewal of the pipeline at which a value of the objective function is minimized.

3. The pipeline renewal support device according to claim 1, wherein
the constraint condition includes a cost condition that the renewal cost of the pipeline is required to satisfy a predetermined condition in a predetermined time period, and
the calculation device is configured to calculate a time for renewal of the pipeline under a constraint condition including the cost condition in the renewal plan calculation process.

4. The pipeline renewal support device according to claim 3, wherein
the cost condition includes a condition that a total renewal cost of the pipeline is required to be a certain value or a predetermined value or less during the time for renewal of the pipeline, and
the calculation device is configured to calculate a time for renewal of the pipeline under a constraint condition including the cost condition in the renewal plan calculation process.

5. The pipeline renewal support device according to claim 2, wherein
the calculation device is configured to,
in the renewal plan calculation process,
acquire a first function and a second function as predetermined functions with respect to time, values of one function at each time before and after the reference time being higher than values of another function constantly,
calculate a future renewal time of the pipeline based on a value of the first function, the objective function, and the constraint condition, and
calculate a future renewal time of the pipeline based on a value of the second function, the objective function, and the constraint condition.

6. The pipeline renewal support device according to claim 1, wherein
the calculation device is configured to
execute an index value calculation process of calculating a predetermined index value indicating a future risk of the pipeline based on the calculated time for renewal of the pipeline, and displaying a relation between the calculated index value and a cost constraint condition of the pipeline.

7. The pipeline renewal support device according to claim 6, wherein
the calculation device is configured to
calculate an index value indicating a future water leakage risk of the pipeline based on the calculated time for renewal of the pipeline, years of service of the pipeline, and a water leakage loss of the pipeline, and display a relation between the calculated index value and the cost constraint condition of the pipeline in the index value calculation process.

8. The pipeline renewal support device according to claim 1, wherein
the calculation device is configured to
display information indicating the calculated time for renewal of the pipeline in the renewal plan calculation process.

9. A pipeline renewal support method implemented by an information processing device comprising:
a renewal plan calculation process of calculating a time for renewal of a pipeline with a predetermined attribute to be performed at a predetermined reference time in the future or at a time before and after the reference time under a predetermined constraint condition on a renewal cost of the pipeline.
